(19) United States
(12) Patent Application Publication
(10) Pub. No.: US 2002/0191089 A1
(43) Pub. Date: Dec. 19, 2002

(54) Electronic imaging apparatus

(75) Inventor: Osamu Ikeda, Yokohama-shi (JP)

Correspondence Address: OLIFF & BERRIDGE, PLC, P.O. Box 19928, Alexandria, VA, 22302, US

(73) Assignee: NIKON Corporation

(21) Appl. No.: 10/217,027

(22) Filed: Aug. 13, 2002

Related U.S. Application Data
(63) Continuation of application No. 08/882,102, filed on Jun. 25, 1997.

(30) Foreign Application Priority Data
Jun. 27, 1996 (JP) 08167129
Feb. 27, 1997 (JP) 09-044189

(51) Int. Cl. H04N 5/225

(52) U.S. Cl. 348/231.7; 348/231.8

(57) ABSTRACT

An electronic imaging apparatus is convenient to operate and can be easily configured according to interface, communication, and memory capacity requirements. The electronic imaging apparatus is constructed so that the imaging device, processing circuit, memory circuit, and central processing unit (CPU) are located within a main housing. The main housing includes an opening for receiving a plurality of PC cards of different types including memory cards and I/O cards. Accordingly, PC cards can be chosen and mounted in the opening to provide the electronic imaging apparatus with desired capacities and capabilities. Within the opening are a plurality of connection terminals that electrically connect to the PC cards. Each connection terminal can receive the different types of PC cards. The imaging device, processing circuit, memory circuit, CPU and each of the plurality of connection terminals are connected to a data bus. The CPU controls the activation of the processing circuit as well as the transfer of information to and from the PC cards connected to the bus via the connection terminals. The electronic imaging apparatus can further include a switching device for specifying information to the CPU about a PC card connected to the bus.

### INCORPORATION BY REFERENCE

The disclosures of the following priority applications are herein incorporated by reference: Japanese Patent Application No. 08-167129, filed Jun. 27, 1996; and Japanese Patent Application No. 09-044189, filed Feb. 27, 1997.

### BACKGROUND OF THE INVENTION

1. Field of Invention

The present invention relates to an electronic imaging apparatus such as an electronic still camera that stores and transfers or transmits photographic image data generated by imaging elements of the apparatus. More particularly, the invention relates to an electronic imaging apparatus that can be selectively connected to a memory device having a proper capacity. The invention also provides a simplified interface connection for transferring data between the electronic imaging apparatus and an external device such as a personal computer.

2. Description of Related Art

Electronic imaging apparatus such as an electronic still camera are known that convert a subject image signal output from an imaging element such as a charge-coupled device (CCD) array into a digital signal. The digital signal is recorded in a storage medium, and transferred to an external device such as a personal computer. The digital signal can also be transmitted via a telephone line.

There is a type of electronic imaging apparatus that is commonly known, which comprises only built-in memory that stores an inputted image, and provides connectors for serial interface communication or parallel interface communication.

The image data that was stored in the built-in memory of the commonly known imaging apparatus is transferred to a personal computer or other device for image processing as serial data or parallel data. Where communication by telephone line is necessary, the image data are transmitted, for example, using a computer and a modem.

In this commonly known type of electronic imaging apparatus, when the built-in memory is filled to maximum capacity with image data, additional photographs cannot be stored. According to a known method, image data are cleared from the built-in memory and transferred to an external device such as a personal computer, so that new image data corresponding to a next photograph can be stored in the built-in memory. Generally, the memory is used repeatedly by erasing unnecessary data to make room for new data.

Another commonly known technique is to provide an electronic imaging apparatus having a main body housing, wherein the housing has a space or recess for receiving one memory card, and a connector within the space to electrically connect the memory card with the electronic imaging apparatus. However, such apparatus do not have a dedicated interface for serial or parallel communication.

Accordingly, data are transferred from such apparatus by removing the memory card from the electronic imaging apparatus, and connecting it to a memory card driver which is linked to a personal computer. Then, image data are transferred from the memory card to the personal computer through the memory card driver.

In the conventional electronic imaging apparatus described above which has only a built-in memory, operation is simple. However, there is a disadvantage that when the memory is filled to capacity with image data, additional data cannot be stored into the memory unless existing data in the memory are erased.

Further, where the image data are to be transferred to an external device such as a computer, an appropriately dedicated interface and connection terminal are required according to the transmission method. It has been necessary to provide as many connection terminals as possible that correspond to the plurality of types.

In the case where a removable memory card is used, the removable memory card is selected to have an appropriate memory capacity. However, the memory capacity may be insufficient. Accordingly, it also has been necessary to exchange a memory card filled with image data with an empty memory card while recording image data.

When image data are transmitted via the telephone line, it has been necessary to provide, for example, a dedicated transmission device in addition to the electronic imaging apparatus for reading image data from the memory card.

### SUMMARY OF THE INVENTION

Accordingly, it is an object of the present invention to provide an electronic imaging apparatus such as an electronic still camera that is convenient to operate and has the ability to freely accept removable cards necessary for desired interface, communication and memory capacity characteristics.

It is another object of the present invention to provide an electronic imaging apparatus such as an electronic still camera that has the capability to simultaneously receive several different types of removable function cards including memory cards, interface cards and communication cards, in a space, cavity or recess in a main housing or body of the electronic imaging apparatus.

It is still another object of the present invention to provide an electronic imaging apparatus such as an electronic still camera that can receive and use a large capacity memory card where interface or communication are not required.

It is a further object of the present invention to provide an electronic imaging apparatus such as an electronic still camera that does not require a dedicated interface card, communication circuit or large capacity memory, etc. to be fixed and enclosed within a main body of the camera, so that the main body of the camera is less expensive.

It is a still further object of the present invention to provide an electronic imaging apparatus such as an electronic still camera having a relatively inexpensive structure that can receive an interface card and/or communication card in the case where the interface card and/or communication card are necessary.

Other objects, advantages and salient features of the invention will become apparent from the detailed description taken in conjunction with the annexed drawings.

### BRIEF DESCRIPTION OF THE DRAWINGS

The invention will be described in detail with reference to the following drawings in which like reference numerals refer to like elements and wherein:

FIG. 1 shows a block diagram of an electronic still camera according to a first embodiment of the invention;

FIG. 2 shows a block diagram of the electronic still camera of FIG. 1, with a memory card inserted;

FIG. 3 shows a block diagram of the electronic still camera of FIG. 1, with two memory cards inserted;

FIG. 4 shows a block diagram of the electronic still camera of FIG. 1, with a memory card inserted;

FIG. 5 shows a block diagram of the electronic still camera of FIG. 1, with a memory card and an interface card inserted;

FIG. 6 shows a block diagram of the electronic still camera of FIG. 1, with a memory card and a communication card inserted;

FIG. 7 shows a perspective view of the electronic still camera shown in either FIG. 5 or FIG. 6;

FIG. 8 shows a perspective view of a PC card for use in the electronic imaging apparatus of the present invention, having a shape of the type I;

FIG. 9 shows a perspective view of a PC card for use in the electronic imaging apparatus of the present invention, having a shape of the type II;

FIG. 10 shows a perspective view of a PC card for use in the electronic imaging apparatus of the present invention, having a shape of the type III;

FIG. 11 shows a perspective view of a PC card for use in the electronic imaging apparatus of the present invention, having a shape of the type IV; and

FIG. 12 shows a perspective view of an interface card or communication card for use in the electronic imaging apparatus of the present invention.

### DETAILED DESCRIPTION OF PREFERRED EMBODIMENTS

The electronic imaging apparatus that achieves the above-mentioned object of the present invention comprises a photographic lens; an imaging element that converts an optical image input through the photographic lens to an electric signal; a processing circuit that processes the electric signal, and outputs an image signal; a memory circuit that records the image signal; a control circuit that controls operation of the processing circuit and the write-read operations involving the memory circuit; a bus that connects to the processing circuit, the memory circuit, and the control circuit; and a main housing that houses the photographic lens, imaging element, processing circuit, memory circuit, control circuit and bus. The main housing includes an opening capable of housing a plurality of function cards, and has a plurality of connector terminals that connect the bus to the function cards housed in the opening.

The processing circuit can comprise an A/D conversion circuit that converts the electric signal output by the imaging element to a digital signal, and can include a circuit that performs compression processing of the digital signal.

In accordance with one aspect of the invention, when a function card having a body thickness greater than or equal to a thickness of a function card having a unit thickness is inserted into the opening in the main housing, the card is connected to one of the plurality of connection terminals inside the opening.

In accordance with another aspect of the invention, the electronic imaging apparatus can include a switching device that sets a card identification number identifying a function card connected to one of the plurality of connection terminals. Where multiple function cards are simultaneously inserted in the opening of the main housing, and each card is connected to one of the plurality of connection terminals, the switching device sets a card identification number for each card.

When a function card housed in the opening is a memory card having a memory circuit, the electronic imaging apparatus may be configured such that an image signal corresponding to an image captured by the electronic imaging apparatus is stored in the memory circuit of a memory card according to the control of the control circuit.

Furthermore, when the function cards housed in the opening are a memory card having a memory circuit and an interface card having an interface function with an external device, the electronic imaging apparatus can be configured so that the control circuit stores the image signal in the memory circuit of the memory card, and transfers the image signal to the external device through the interface card.

Furthermore, when the function cards housed in the opening are a memory card having a memory circuit and a communication interface card having an interface function with an external device connected to the communication interface card through a communication circuit, the electronic imaging apparatus can be configured so that the control circuit stores the image signal in the memory circuit of the memory card, and transmits the image signal to the external device through the communication interface card.

Furthermore, when the function cards housed in the opening are a memory card having a memory circuit and an interface card having an interface function with an external device, the electronic imaging apparatus can be configured so that the control circuit transfers an image signal from the external device to the memory circuit of the memory card through the interface card.

Furthermore, when the function cards housed in the opening are a memory card having a memory circuit and a communication card for communicating with an external device through a communication circuit, the electronic imaging apparatus can be configured so that the control circuit transfers an image signal from the external device to the memory circuit of the memory card through the communication card.

Furthermore, the electronic imaging apparatus can include a memory, whereby the control circuit transfers program data from an external device to the memory through an interface card or a communication card. Subsequently, the transferred program data stored in memory are executed by the control circuit.

Accordingly, various types of PC cards such as the memory card, interface card, and communication card and others can be connected to the electronic imaging apparatus in a variety of combinations. PC cards which are connected as described above are identified to the electronic imaging apparatus according to their function, thereby allowing the electronic imaging apparatus to appropriately control operations involving the function cards.

Thus, an electronic imaging apparatus such as an electronic still camera that is convenient to operate and has the ability to freely accept removable cards necessary for desired interface, communication and memory capacity characteristics, is realized.

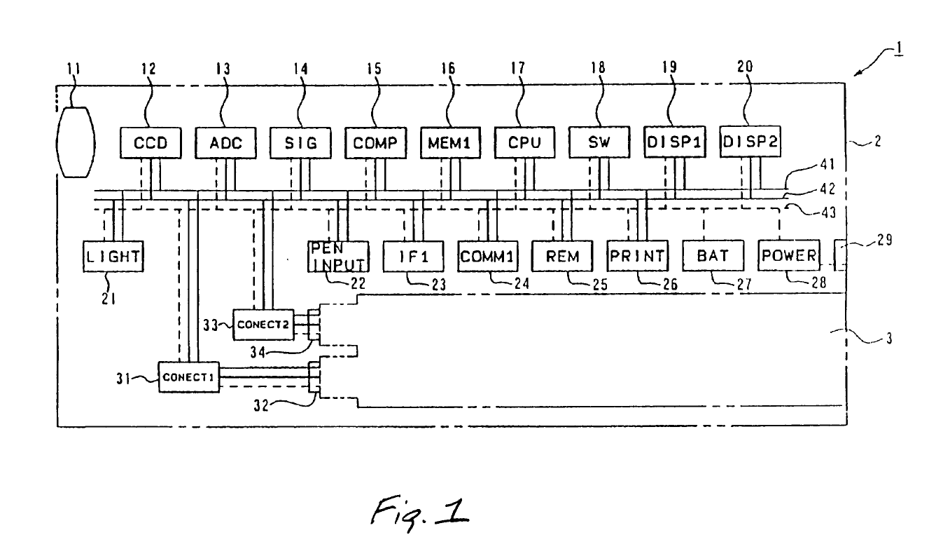

FIG. 1 shows an electronic still camera 1 according to a first preferred embodiment of the present invention. The present invention is not restricted to an electronic still camera, and has broad application in the field of electronic imaging. For example, the present invention can be applied to a moving image camera.

FIG. 1 shows internal block circuitry that performs various types of processing. A photographic lens 11 is arranged in the interior of the electronic still camera main body 2, and the PC card storage space 3 is capable of receiving an IC memory card or an I/O card (hereafter, referred to as PC cards). The PC cards comply with one or more of the PCMCIA (Personal Computer Memory Card International Association) and JEIDA (Japan Electronic Industry Development Association) standards.

Light that has passed through the photographic lens 11 is converted to an electric signal by means of the charge coupled device (CCD) 12. The electric signal output from the CCD sensor device 12 is converted to a digital signal by an analog-to-digital (A/D) conversion circuit 13. Subsequently, the digital signal output from the A/D conversion circuit 13 is converted to an image signal by the signal processing circuit 14.

Furthermore, the image signal output by the signal processing circuit 14 is compressed at the image compression circuit 15. Also provided are a flash memory device (not shown) for storing the compressed photographic image signal, and a central processing unit (CPU) 17. The CPU 17 functions as a control circuit which controls a first memory device 16. The first memory device 16 can be a static random access memory (SRAM) or other suitable memory. The CPU performs control functions by executing a control program. The control program, or program data, is stored in the first memory device 16 or in another memory device (not shown) attached to the CPU 17.

The electronic still camera further comprises a setting display component 19 that displays, for example, various photographic conditions. The photographic conditions are determined by operation of a switching device 18 including a release switch. The release switch of the switching device 18 causes the electronic still camera 1 to commence a photographing operation, and will be described in greater detail further below. The electronic still camera also includes a play back imaging display component 20 that plays back and displays the photographic image data recorded in the first memory device 16.

A flash 21 is shown in FIG. 1. The pen input processing circuit 22 is used to input data to the electronic still camera 1. For example, the pen input processing circuit 22 can input data such as a line drawing, where the drawing is created by exerting pressure on the screen of the play back imaging display component 20 using the point of a pen.

A PC card interface 23 is an interface device that sends and/or receives a signal passing between, for example, an external computer (not shown in FIG. 1) and the electronic still camera 1, via a dedicated interface connection terminal (not shown in FIG. 1). The PC card interface 23 also has an interface circuit for interfacing with or through a PC card. Accordingly, the PC card interface 23 performs a protocol exchanging process between the first memory device 16 and a PC card.

A first communication processing circuit 24 is a communication device that transfers data through a dedicated communication connection terminal (not shown in FIG. 1) and sends and/or receives a signal between a telephone line and a dedicated line, e.g., a local area network (LAN).

A remote control processing circuit 25 controls the electronic still camera 1 via a remote control member connected to a dedicated remote terminal (not shown in FIG. 1).

A print output circuit 26 prints photographic image data stored in the first memory device 16 by passing the photographic image data to a printer via a dedicated printer connection terminal (not shown in FIG. 1).

A battery 27, e.g., a lithium battery, supplies electric power to the electronic still camera 1. An external power source processing circuit 28 is connected to an external power source connection terminal 29, so that power can be supplied from an external source. Power from an external source is useful when, for example, the battery 27 is being changed.

A first connector 31 and a terminal 32 as well as a second connector 33 and a terminal 34 are disposed in the PC card storage space 3, and are configured so that PC cards connected to the terminals 32 and 34 lie one on top of the other. Additionally, the PC card storage space 3 of the first preferred embodiment can store two PC cards of a standard type II, or a PC card of a type III, as described in greater detail below.

Buses 41, 42 and 43 transfer data signals corresponding to photographic data and control signals for performing camera control, and also transmit power from the battery 27 and the external power source processing circuit 28 to other elements and circuits within the electronic still camera 1.

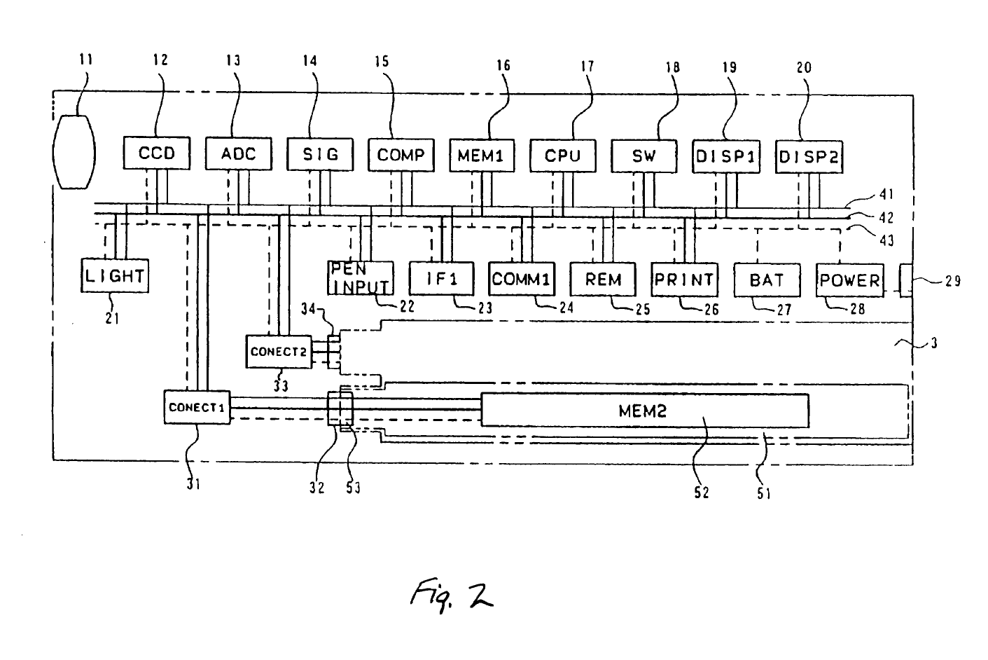

FIGS. 2-6 each show example usages of the electronic still camera 1 shown in FIG. 1.

FIG. 2 shows the situation where a memory card 51 of the type II is mount-connected to the connector 31 via the terminal 32. As shown in FIG. 2, only a portion of the PC card storage space 3 is used by the PC card 51. Accordingly, that portion of the PC card storage space 3 that corresponds to the connector 33 and terminal 34 is unused.

A second memory device 52 is mounted within the memory card 51, and is connected to the various electronic circuits within the electronic still camera 1 via the busses 41, 42 and 43. The busses 41, 42 and 43 connect to the second memory device 52 through the connector 31 as well as the connection terminals 53 and 32, which have a male and female relationship.

The first memory device 16 and the second memory device 52 can be selectively activated by the CPU 17 and the setting of the switching device 18. When the first memory device 16 and the second memory device 52 are activated, a photographic image can be recorded. In particular, when the switching device 18 is properly set, the CPU 17 recognizes that the memory card 51 is connected.

In this way, a continuous or a non-continuous address number can be assigned to the first memory device 16 and the second memory device 52. Accordingly, when reading or writing to the first memory device 16 or to the second memory device 52, an enable signal, together with the address number of the first memory device 16 or the second memory device 52, is sent from the CPU 17 to the first memory device 16 or the second memory device 52.

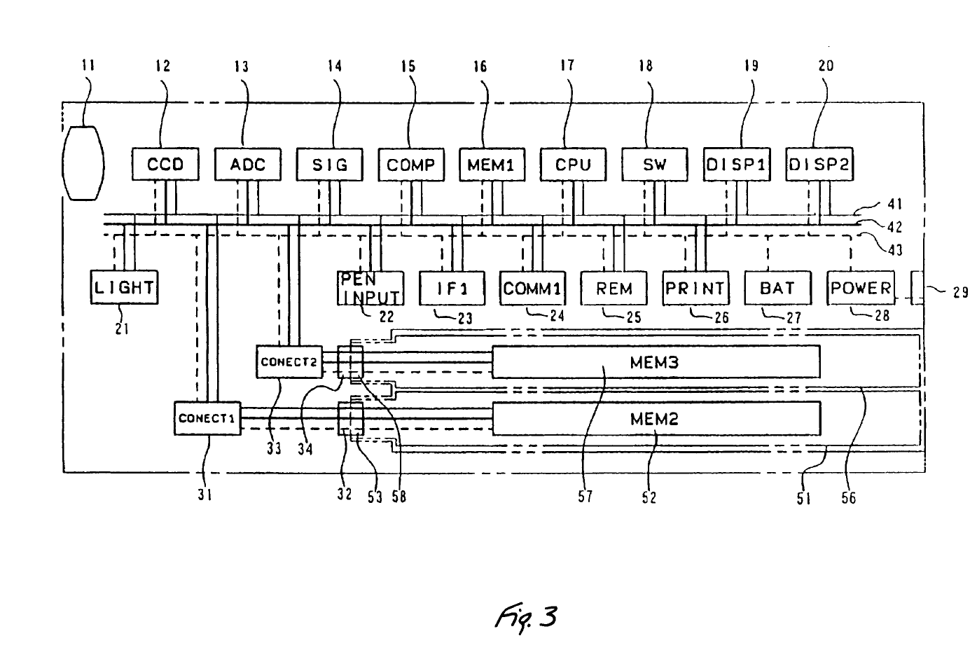

FIG. 3 shows an example where two memory cards 51 and 56 of the type II, are mount-connected and used in the electronic still camera 1. In this example, the PC card storage space 3 is completely utilized.

The second memory device 52 within the memory card 51 is connected to various elements and electronic circuits of the electronic still camera 1 via the buses 41, 42 and 43 through the connection terminals 53 and 32, which have a male and female relationship.

In the same manner, a third memory device 57 within the memory card 56 is connected to various elements and electronic circuits of the electronic still camera 1 via the buses 41, 42 and 43 through the connection terminals 58 and 34, which have a male and female relationship. The memory devices 16, 52 and 57 can be selectively activated to accept data by the CPU 17 and the setting of the switching device 18, thereby allowing a photographic image to be recorded.

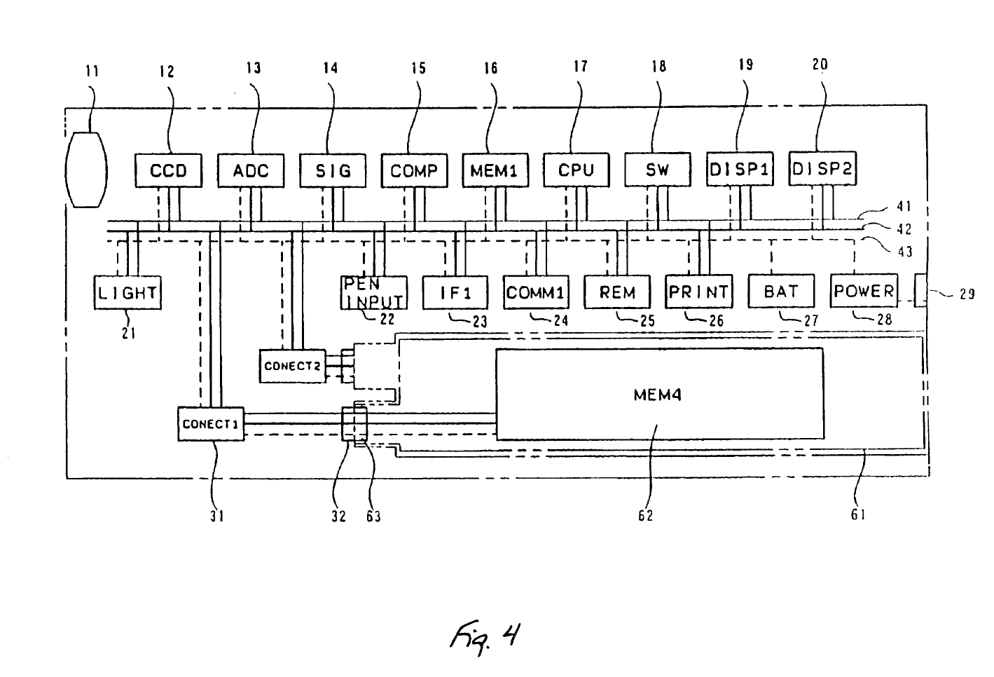

FIG. 4 shows a situation where a memory card 61 of the type III, is mount-connected and used in the electronic still camera 1. In this example, the PC card storage space 3 is completely utilized.

A fourth memory device 62 within the memory card 61 is connected to various elements and electronic circuits of the electronic still camera 1 via the buses 41, 42 and 43 through the connection terminals 63 and 32, which have a male and female relationship. The memory devices 16 and 62 can be selectively activated for writing data in the same way as described above with respect to FIGS. 2 and 3, by the CPU 17 and the setting of the switching device 18. Thus, a photographic image can be recorded.

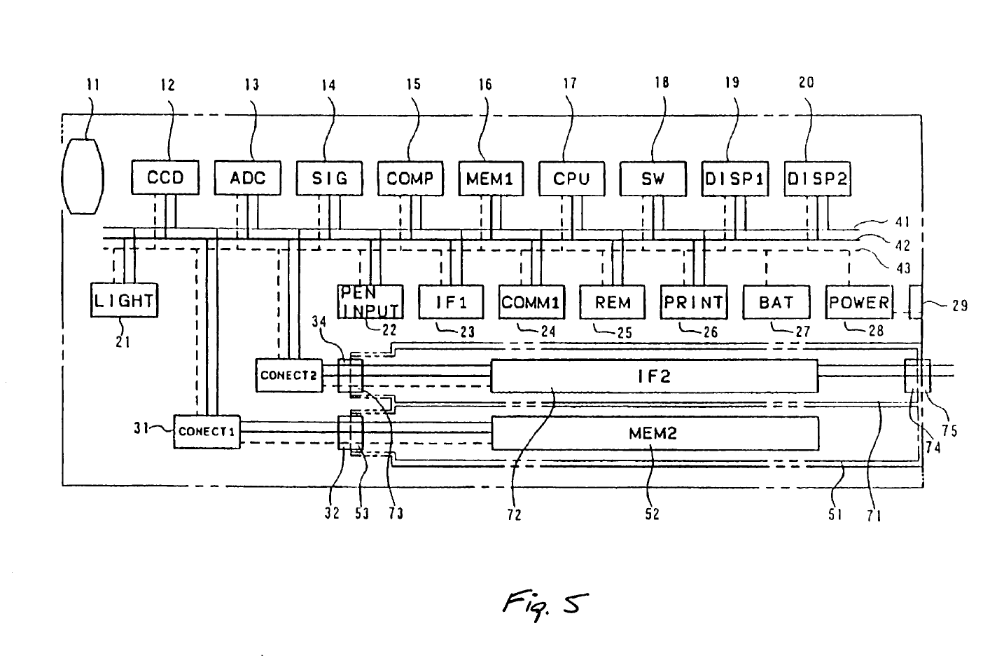

FIG. 5 shows a situation where the memory card 51 and an interface card 71 are mount-connected and used in the electronic still camera 1 shown in FIG. 1. Both of the cards 51 and 71 are of the type II. In this case also, the PC card storage space 3 is completely utilized.

In addition, a connection terminal 74 as well as connector 75 are exposed from the rear end portion of the interface card 71.

The second memory device 52 that is within the memory card 51 is connected to the electronic circuits of the electronic still camera 1 through the connection terminals 53 and 32 and the buses 41, 42 and 43. The second interface circuit 72 that is within the interface card 71 is likewise connected to the electronic circuits of the electronic still camera 1 through the connection terminals 73 and 34 and the buses 41, 42 and 43.

The first and second memory devices 16 and 52 can be selectively activated by way the CPU 17 and the setting of the switching device 18, thereby allowing a photographic image to be recorded. In addition, the PC card interface 23 and interface circuit 72 can be selectively activated by the CPU 17 in accordance with an interruption number set by way of the switching device 18. Thus, photographic image data can be transferred between the electronic still camera 1 and an external device.

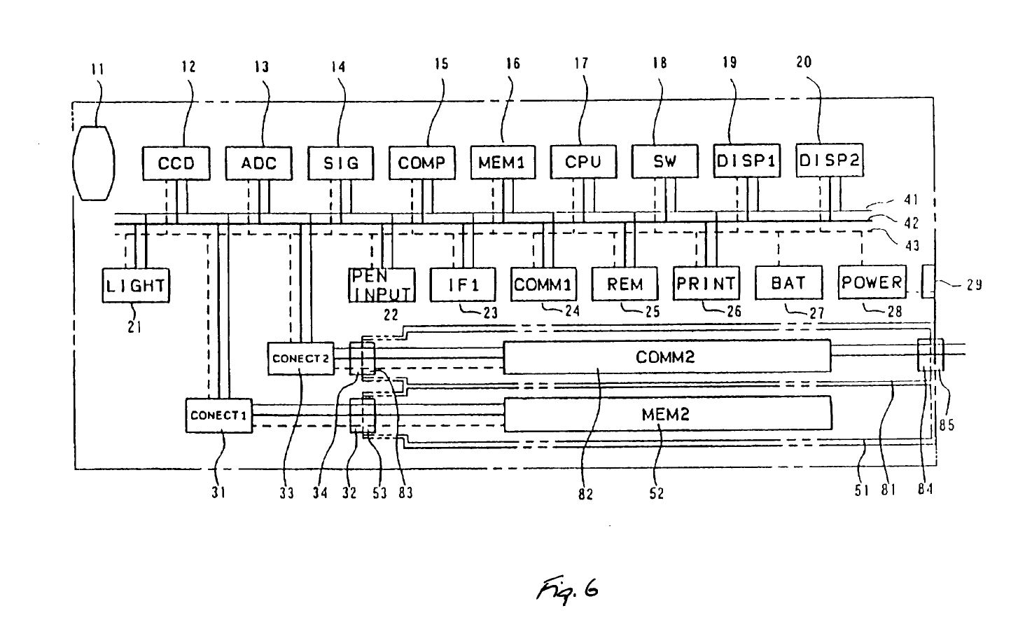

FIG. 6 shows a case where the memory card 51 and a communication card 81 are mount-connected and used in the electronic still camera 1 of FIG. 1. The two cards 51, 81 are of the type II. Accordingly, the PC card storage space 3 is completely utilized. In addition, a connection terminal 84 and a connector 85 are exposed from the rear end portion of the communication card 81.

The second memory device 52 within the memory card 51 is connected to electronic circuits and elements of the electronic still camera 1 via the buses 41, 42 and 43 through the connection terminals 53 and 32 that have a male and female relationship. A second communication processing circuit 82 within the communication card 81 is connected to electronic circuits and elements of the electronic still camera 1 via the buses 41, 42 and 43 through the connection terminals 83 and 34 that have a male and female relationship.

The first and second memory devices 16 and 52 can be selectively activated as described above with respect to, e.g., FIGS. 2 and 3, thereby allowing the recording of the photographic image to be performed. In addition, the PC card interface 23 and the second communication processing circuit 82 can be selectively activated by the CPU 17 in accordance with an interruption number set by way of the switching device 18.

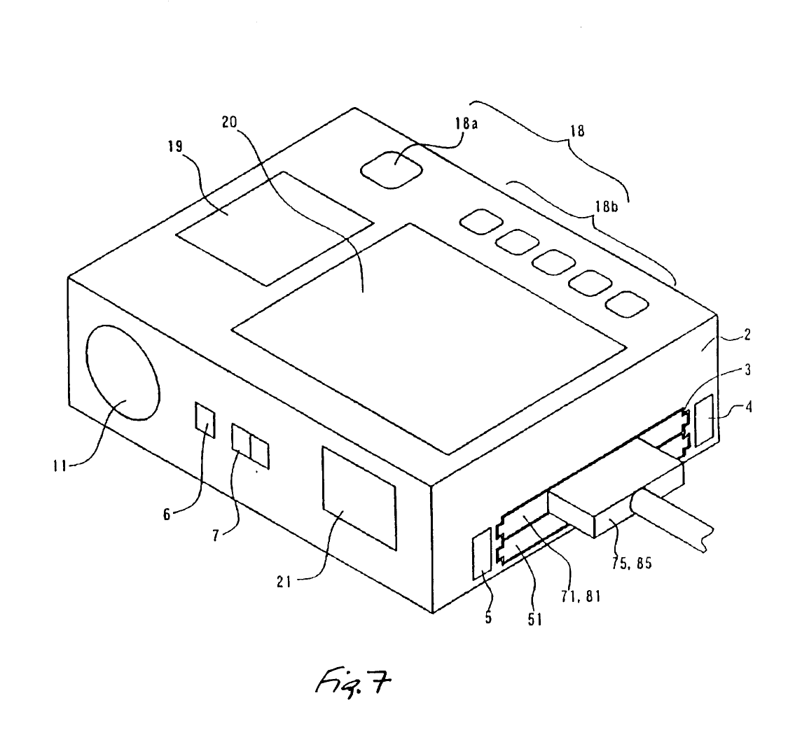

FIG. 7 shows a perspective view of an electronic still camera consistent with FIGS. 5 and 6.

In front of the camera main body 2, the following are arranged: a photographic lens 11; a photometric window 6; an auto-focus detection window 7; and a flash 21 as the lighting device, as shown in FIG. 7. The photometric window 6 and the auto-focus detection window 7 can perform photometry and ranging functions prior to capturing and recording an image.

Based on information obtained by, e.g., the photometric window 6 and the auto-focus detection window 7, the exposure setting and auto-focus functions can be performed. These functions are commonly known with respect to existing electronic cameras, and accordingly the details are omitted from this description.

FIG. 7 shows a switching device 18 in an upper surface of a camera main body 2 of an electronic still camera. The switching device 18 includes a release switch 18a and setting switches 18b. A person using the electronic still camera can actuate the setting switches 18b to identify and/or set an interruption number for various types of PC cards which are mount-connected in the PC card storage space 3. The camera main body 2 also features a setting display component 19 for displaying photographic conditions and setting information specified by the switching device 18, and a play back imaging display component 20 that can display recorded images.

Each of the setting display component 19 and the play back imaging display component 20 are preferably implemented using a liquid-crystal display panel.

FIG. 7 also shows the memory card 51 and the interface card 71 or the communication card 81 stored in the PC card storage space 3.

Additionally, card eject buttons 4 and 5 are shown in FIG. 7 arranged at a side surface of the camera main body 2. The card eject buttons 4 and 5 can be used to eject PC cards (51, 71, 81) located inside the PC card storage space 3. When the card eject buttons 4 and 5 are not operated, the PC cards are latched so that they cannot be pulled out.

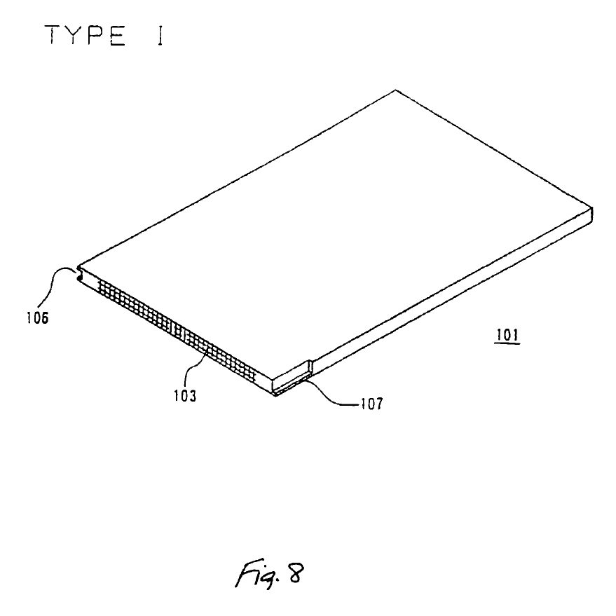

FIGS. 8-11 show a perspective views of various types of PC cards which can be used in an electronic still camera according to the invention. In particular, FIGS. 8-11 show PC cards of types I-IV, respectively.

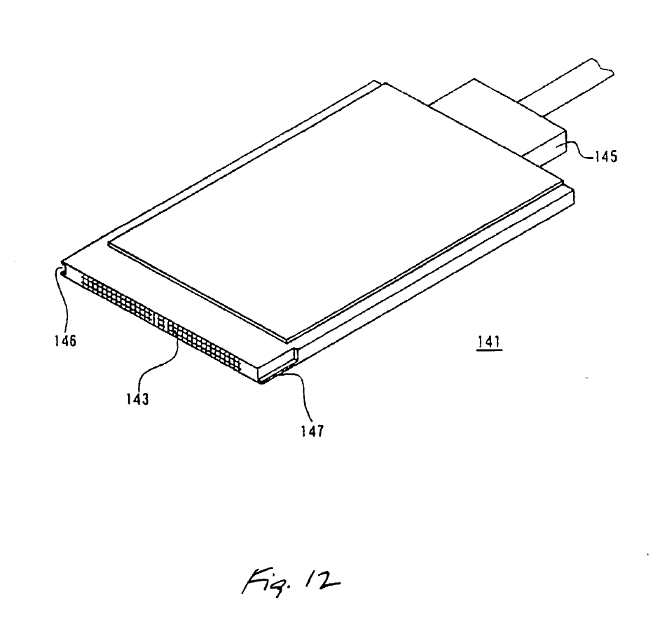

FIG. 12 shows a perspective view of an interface card or a communication card which can be used with an electronic still camera according to the invention.

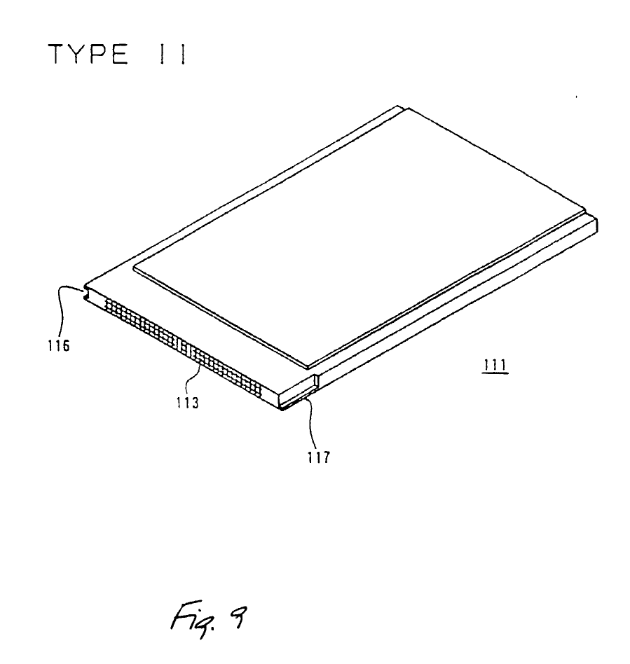

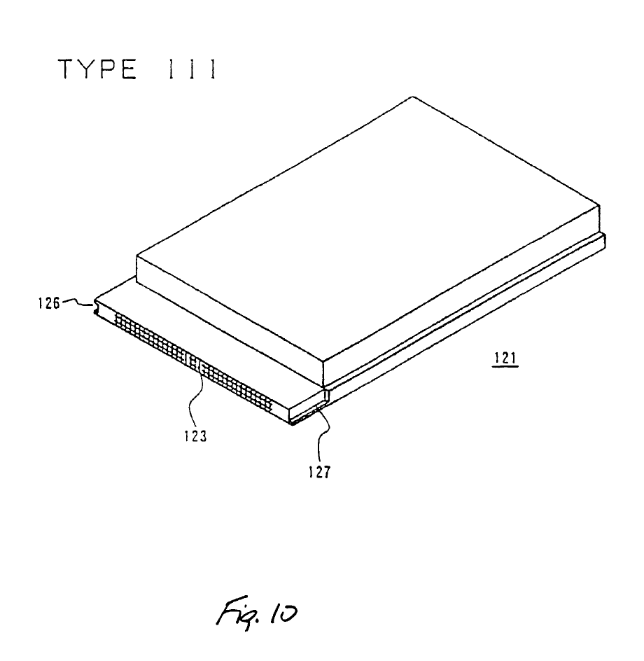

FIGS. 8-11 show perspective views of PC cards for use with the invention, including IC memory cards 101, 111, 121 that conform to the PCMCIA/JEIDA standards previously mentioned. The memory card 101 in FIG. 8 is of the type I, memory card 111 in FIG. 9 is of the type II, and memory card 121 in FIG. 10 is of the type III.

FIG. 12 shows a type IV PC input/output (I/O) card 131 for use with the invention.

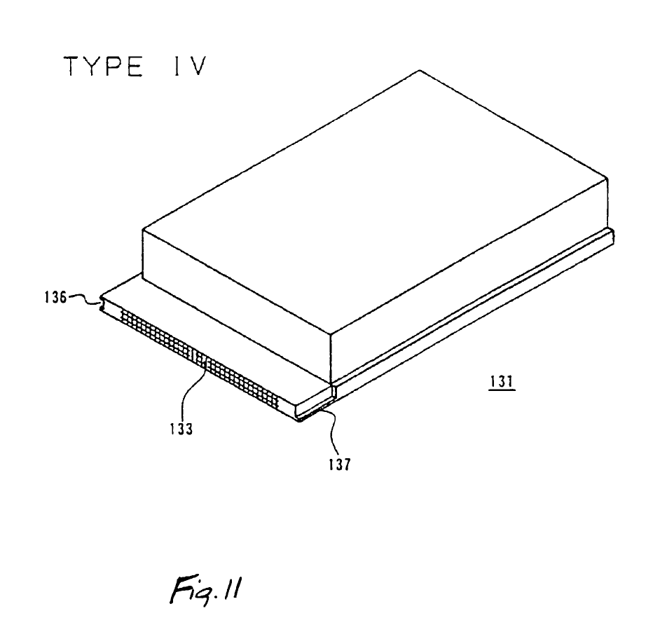

The connection terminals 103, 113, 123, 133 each have 68 pins and are arranged at a front end that first enters the PC card storage space 3 when each card is inserted into the PC card storage space 3. In order to regulate the front and rear of the insertion direction, crosswise asymmetrical notches 106 and 107 (FIG. 8), 116 and 117 (FIG. 9), 126 and 127 (FIG. 10), 136 and 137 (FIG. 11), and 146 and 147 (FIG. 12) are arranged.

A PC card of type I as described above and having standard dimensions has a width of 54.0±0.1 millimeters (mm), a length of 85.6±0.2 mm, and a thickness of 3.3±0.1 mm.

A PC card of type II having standard dimensions has a width of 54.0±0.1 mm, a length of 85.6±0.2 mm, and a maximum main body thickness of approximately 5.0 mm. In the first preferred embodiment of the invention, the thickness of the main body of the PC card of type I of 3.3±0.1 mm or the thickness of the main body of the PC card of type II of 5.0 mm is regarded as the unit thickness.

A PC card of type III having standard dimensions has a width of 54.0±0.1 mm, a length of 85.6±0.2 mm, and a maximum main body thickness of approximately 10.5 mm.

A PC card of type IV having standard dimensions has a width of 54.0±0.1 mm, a length of 85.6±0.2 mm, and a maximum thickness of approximately 16.0 mm.

FIG. 12 further shows a perspective view of a PC card that is an interface card or a communication card 141 having a shape and dimensions consistent with the PC card of type II described above. The connection terminals 143 are arranged at a front end of the interface card or communication card 141 that first enters the PC card storage space 3 when the interface card or the communication card 141 is inserted into the PC card storage space 3.

FIG. 12 also shows crosswise asymmetrical notches 146 and 147 in the interface card or communication card 141. The notches 146 and 147 are arranged to regulate the front and rear of the insertion direction, and ensure that the card 141 is properly inserted into the PC card storage space 3. At the insertion direction rear end, a connector 145 is connected to the card 141 in a removable manner. A cable and connector linking the connector 145 to computer equipment or to a telephone line are well known in the art, and are thus not described or shown in FIG. 12.

The terminals 103, 113, 123, 133 and 143 of the PC cards shown in FIGS. 8-12 are 68 pin connectors, and have the notches 106, 107, 116, 117, 126, 127, 136, 137, 146, and 147 in order to prevent a reverse hook-up into the PC card storage space 3. The terminals 103, 113, 123, 133 and 143 can properly connect and mate with the terminals 32 and 34 arranged within the PC card storage space 3.

The standardized widths and lengths of the PC cards of types I-IV are the same, i.e., a width of 54.0±0.1 mm and a length of 85.6±0.2 mm. Accordingly, it is desirable to arrange the PC card storage space 3 so that a PC card of a type I-IV that has a maximum standard thickness can be mount-connected within the PC card storage space 3. Preferably, a height of the opening of the PC card storage space 3 is equal to or larger than the maximum standard thickness of the PC card.

It is also possible to mount-connect multiple PC cards of different types in the PC card storage space 3, or to mount-connect a plurality of PC cards of the same type in the range of the maximum standard thickness, wherein the combined thicknesses of the mount-connected PC cards are less than or equal to the height of the opening of the PC card storage space 3.

For example, FIGS. 2-6 show various types of PC cards installed in the PC card storage space 3 of the electronic still camera 1. Up to two PC cards of type II can be simultaneously mount-connected in the PC card storage space 3. Alternatively, one PC card of type III can be mount-connected in the PC card storage space 3.

Further, it is possible to use in proper combination a memory card, interface card, communication card and so forth. Regarding the capacity of the memory card, because commonly known memory cards of type II typically have a maximum capacity of between 10 megabytes (MB) and 20 MB, and commonly known memory cards of type III typically have a maximum capacity of 100 MB and beyond, it is possible to select and use a memory card or combination of memory cards that appropriately satisfies memory capacity requirements for particular photographing situations or conditions.

A photographing operation of the electronic still camera 1 is described below. The CPU 17 controls fundamental photographic operations of the electronic still camera in accordance with a control program stored in a read-only-memory (ROM) (not shown) attached to the CPU 17. The CPU 17 can control additional photographic operations in accordance with an additional control program data stored in an option memory card that is inserted into the PC card storage space 3.

Preceding the photographic operation, exposure conditions such as shutter speed, diaphragm stop or aperture size, as well as setting of the PC card which is mount-connected to the electronic still camera 1, can be specified by actuating the setting switches 18b. The settings can be displayed on the photographic conditions setting display component 19 and thus confirmed by a user of the camera.

Moreover, settings and/or modes for configuring the settings of the setting switches 18b can be designated in advance according to the control program or the additional control program data described above and executed by the CPU 17. For example, a mode could be designated in advance that would associate a specific group of settings with one of the setting switches 18b, so that pressing that one of the setting switches 18b would cause all of the settings within the specific group to be implemented.

Now, selection of the second memory device 52 together with the second interface circuit 72 will be described with reference to FIG. 5. Selection of the second memory device 52 together with the second communication circuit 82 will also be described with reference to FIG. 6.

When a user operates the release switch 18a, light from the photographic subject, which has passed through the photographic lens 11, is filtered by a plurality of color filters (not shown) of complementary colors, e.g., yellow (Ye), cyan (Cy), magenta (Mg), and green (G).

The filtered light is converted into electric signals by elements of the CCD sensor device 12, where each element of the CCD sensor device 12 corresponds to one of the color filters. Accordingly, elements of the CCD sensor device 12 output electronic signals corresponding to the colors Ye, Cy, Mg, and G.

The A/D conversion circuit 13 converts these electronic signals corresponding to the colors Ye, Cy, Mg, and G into digital signals.

Subsequently, the signal processing circuit 14, which includes a digital signal processor (DSP), generates an image signal from the digital signals output by the A/D conversion circuit 13. The image signals in this embodiment are a) the luminance signal Y generated by the color conversion which is one of the DSP processes, b) a first color difference signal (R−Y) which is the difference between the luminance signal Y and the red color signal R, and c) a second color difference signal (B−Y) which is the difference between the luminance signal Y and the blue color signal B.

Further, the signal processing circuit 14 performs the color conversion, and additionally, also performs the correction of the picture interpolation, accentuation of the horizontal/vertical profile, and γ (gamma) correction. Therefore, after these processes are performed, the signal processing circuit 14 outputs the image signal to the image compression circuit 15.

The image compression circuit 15 stores the image signal output from the signal processing circuit 14 and then compresses the image signal in accordance with JPEG (Joint Photographic Experts Group) standards.

Although complementary colors are used in the color filter over the CCD sensor device 12 in this embodiment, a color filter of 3 primary colors R (red), G (green), and B (blue) can alternatively be used. In such a case, the signal processing circuit 14 can generate the image signal from the primary colors of R, G, and B.

Operation of the release switch 18a will now be described. If the release switch 18a is partially depressed, the CPU 17 will control the CCD sensor device 12, A/D conversion circuit 13, signal processing circuit 14, and image compression circuit 15, and perform the image capture operations described above.

Subsequently, the signal accumulation time of the CCD photographic elements 12 is adjusted based a) on the luminance level of the image signal prior to image compression, or b) on a light amount level which is received from the photometric window 6, so that the image will have an optimal brightness.

A user of the electronic still camera takes a picture by fully depressing the release switch 18a. When the release switch 18a is fully depressed, the CPU 17 gathers the image signal in accordance with the adjusted signal accumulation time and stores the image signal into the memory of the image compression circuit 15.

Since the electronic shutter allows the CCD sensor device 12 to only read electric charge accumulated during the adjusted signal accumulation time, the image signal has an optimal brightness.

Subsequently, the image signal is compressed in accordance with, e.g., JPEG standards by the image compression circuit 15. The CPU 17 writes the compressed image signal in a specified address area of the memory device 52. The specified address area is previously selected in the DOS-FAT (Disk Operating System File Allocation Table) system so that the compressed image signal data can be used, e.g., with a personal computer that is loaded with MS-DOS, a type of operating system (OS).

Whenever the release switch 18a is fully depressed, a compressed image signal is written into a different area of the memory device 52. Thus, a plurality of image signals are recorded in the memory device 52.

In this embodiment, the image signal compression is performed by the image compression circuit 15. Alternatively, in the situation where a lower number of recorded images is acceptable, image signals can be written directly into the memory device 52, without compression.

When the user completes photographing operations, the memory card 51 is taken out by means of one or the other of the card eject buttons 4 and 5 from the PC card storage space 3 of the camera main body 2. The memory card 51 can then be inserted into a memory card driver (not shown) which is connected to a personal computer (not shown).

The memory device 52 of the memory card 51 is connected to the memory card driver and thus it is connected electronically to the personal computer. In this way, the personal computer can access the memory device 52 of the memory card 51, and read the image data which is stored in the memory device 52.

Moreover, an example of performing the memory operation together with photography imaging by using the memory card can be realized by utilizing the memory device 52 of FIG. 2, and the memory device 52 and 57 of FIG. 3, and the memory device 62 of FIG. 4, and the memory device 52 of FIG. 5, and the memory device 52 of FIG. 6.

The transfer of data into external equipment such as a computer for image data can be performed as described herein.

In FIGS. 5 and 7, the second memory device 52 that is within the memory card 51 is connected to circuits of various types within the electronic still camera 1 via the buses 41, 42 and 43 through the connection terminals 53 and 32. The interface circuit 72 that is within the interface card 71 is connected to circuits of various types within the electronic still camera 1 via the buses 41, 42 and 43 through the connection terminals 73 and 34.

The memory devices 16 and 52 can be selectively activated for reading and writing by the CPU 17. Reading of photographic images from the memory devices 16 and 52 is enabled by an enable signal from the CPU 17.

In addition, the PC card interface 23 and interface circuit 72 also can be activated selectively by the CPU 17 and the setting of the switching device 18. However, in this situation photographic image data are transferred by way of the interface circuit 72 that is within the interface card 71.

The memory device 52 and the interface circuit 72 can be selected by the switching device 18. The settings can be confirmed during the selection process by displaying the setting conditions on the setting display component 19.

In addition, since appropriate actuation of the switching device 18 can cause image data that are recorded in the memory device 52 to be played back or displayed on the play back imaging display component 20, a recorded image can be confirmed by a user of the electronic still camera on the play back imaging display component 20, and data corresponding to a confirmed recorded image can be transferred in accordance with a selection made using the switching device 18.

After image data have been selected, the image data can be transferred from the memory device 52 to external equipment such as a computer via the connection terminals 53 and 32 through the connector 31, the buses 41, 42, and 43, the connector 33, the connection terminals 34 and 73, the interface circuit 72, and the connection terminals 74 and 75.

In this situation, it is not necessary to detach the memory card 51 and the interface card 71 from within the PC card storage space 3 of the electronic still camera main body 2. The interface card 71 is compatible with, for example the USB (Universal Serial Bus) type, the SCSI type, the GPIB type and so forth, and can be selected.

In addition to transferring image data from the electronic still camera to an external device, such as a personal computer, it is also possible according the invention to transfer image data from an external device to the electronic still camera or to a memory card inserted in the PC card storage space 3 of the electronic still camera. In addition, program data to allow the CPU 17 to perform additional functions can be transferred from an external device to the electronic still camera or to a memory card inserted in the PC card storage space 3 of the electronic still camera.

For example, program data or image data sent from the external equipment can be received by way of the interface circuit 72 of the interface card 71 which is set in the PC card storage space 3. See, e.g., FIG. 5. Next, the data are transferred from the interface circuit 72 to the first memory device 16 within the electronic still camera main body 2 or to the memory device 52 of the memory card 51 which is set in the PC card storage space 3.

The switch device 18 determines whether the data are transferred to the first memory device 16 within the electronic still camera main body 2, or to the memory device 52 of the memory card 51. More specifically, when the data sent from the external equipment are the program data, the data are transferred to the first memory device 16 within the electronic still camera main body 2 thereby allowing the electronic still camera 1 to perform additional functions.

Transmission of image data by means of a telephone wire or so forth can be performed as follows.

In FIGS. 6 and 7, the second memory device 52 within the memory card 51 is connected to electronic circuits within the electronic still camera 1 via the buses 41, 42 and 43 through the connection terminals 53 and 32.

The second communication circuit 82 within the communication card 81 is connected to electronic circuits within the electronic still camera 1 via the buses 41, 42 and 43 through the connection terminals 83 and 34. The memory devices 16 and 52 can be selectively activated by the CPU 17 and by the setting of the switching device 18, thereby allowing photographic images to be read.

In addition, the communication circuits 24 and 82 also can be selectively activated by the CPU 17 and the setting of the switching device 18. In such a case, image data are transmitted by way of the communication circuit 82 that is within the communication card 81.

The user of the electronic still camera can select the memory device 52 using the switching device 18. During the selection operation, the selections can be confirmed by displaying the setting conditions on the setting display component 19. In addition, since the image data that are recorded in the memory device 52 can be played back on the play back imaging display component 20, the user can confirm the image played back on the play back imaging display component 20, and can accordingly operate the switching device 18 to transfer the image data.

After the image data have been selected, the image data are transmitted from the memory device 52 to external equipment such as a telephone line or a LAN from the connection terminals 53 and 32 through the connector 31, the buses 41, 42, and 43, the connector 33, the connection terminals 34 and 83, the communication circuit 82, and the connection terminals 84 and 85.

In this situation, it is not necessary to detach the memory card 51 and the communication card 81 from within the PC card storage space 3 of the camera main body 2.

In addition, it also is possible to transmit image data or additional program data from an external device (not shown) to the electronic still camera 1 through public telephone lines.

In this case, the additional program data or the image data sent from the other data processing device are received by way of the communication circuit 82 of the communication card 81 (see FIG. 5) which is mount-connected in the PC card storage space 3. The received data are transmitted from the communication circuit 82 to either the first memory device 16 within the electronic still camera main body 2 or to the memory device 52 of the memory card 51 which is mount-connected in the PC card storage space 3.

Whether data are transferred into the first memory device 16 within the electronic still camera main body 2 or the memory device 52 of the memory card 51 is determined by the switching device 18, which indicates where the data should be transferred. Specifically, when data sent from the external equipment are additional program data, the program data are transmitted to the first memory device 16 within the electronic still camera main body 2, rather than to the memory device 52. Thus, the electronic still camera 1 can perform additional option functions when the CPU 17 executes the additional program data.

While this invention has been described in conjunction with specific embodiment outlined above, it is evident that many alternatives, modifications and variations will be apparent to those skilled in the art.

For example, in the electronic still camera 1 according to the aforementioned composition, an explanation wherein two PC cards of the type II or one of the type III, both types conforming to the PCMCIA/JEIDA standards, were provided as the space in regards to the PC card storage space 3 which is installed within the camera main body 2. However, a space of sufficient size so as to allow the storage of three of the type II, or 1 of the type II and 1 type III, is also possible.

In addition, each of the electric circuits within the electronic still camera 1, for example, the image compression circuit 15, the play back imaging display component 20, the pen input processing circuit 22, the PC card interface 23, the first communication circuit 24, the remote control processing circuit 25, the print output circuit 26, and the external power source processing circuit 28 can be selectively included or omitted depending on the particular application of the invention.

Further, the method for setting each photographic condition, each type of processing of the photographic data, the memory, the play back method of the image and so forth, and the selective designation from among a plurality of memory devices, the selective designation from among the plurality of interfaces, the selective designation from among the plurality of communication methods, the selective designation of image data, the transfer method of the image data, and the transmission method of the image data and so forth may also be included, adjusted, or omitted according to the specific application of the invention.

As described in detail above, a plurality of types of memory cards, interface cards and communication cards and so forth may be selectively and simultaneously mounted in the internal space of the electronic imaging apparatus according to the present invention.

In this way, the data within the memory card can be directly and easily transferred via an interface and/or a communication link. In addition, when an interface or a communication link is not necessary, greater amounts of image data can be gathered because a larger memory card can be used.

In addition, since there is no need to install dedicated interface and communication circuits and a large capacity memory in a fixed manner in the electronic imaging device main body, a relatively inexpensive electronic imaging device main body can be realized. More specifically, when a specific interface circuit or communication circuit is necessary, such a circuit can be inexpensively included by mounting an interface card or a communication card on a standardized connector of the imaging device main body.

Accordingly, the preferred embodiment of the invention as set forth herein is intended to be illustrative, not limiting. Various changes may be made without departing from the scope of the invention as defined in the following claims.

What is claimed is:

1. An electronic imaging apparatus comprising:
a photographic lens;
an imaging element that converts an optical image input through the photographic lens to an electric signal;
a processing circuit that processes the electric signal and outputs an image signal;
a memory circuit that stores the image signal;
a control circuit that controls operation of the processing circuit and write-read operations involving the memory circuit;
a bus connected to each of the processing circuit, the memory circuit, and the control circuit; and
a main housing that houses the photographic lens, the imaging element, the processing circuit, the memory circuit, the control circuit and the bus, the main housing comprising an opening that can simultaneously mount within the opening a plurality of function cards independently of each other, and a plurality of data communication couplings disposed in the opening, wherein each of the data communication couplings is adapted to make a data coupling between the bus and a plurality of types of the function cards.

2. An electronic imaging apparatus according to claim 1, wherein the processing circuit comprises:
an analog-to-digital conversion circuit that converts the electric signal output by the imaging element to a digital signal; and
a circuit that performs compression processing on the output of the analog-to-digital conversion circuit.

3. An electronic imaging apparatus according to claim 1, wherein the opening is adapted to receive function cards of different thicknesses.

4. An electronic imaging apparatus according to claim 1, further comprising:
a switching device, wherein the switching device sets card identification information for identifying a function card connected to one of the plurality of data communication couplings.

5. An electronic imaging apparatus according to claim 4, wherein the card identification information identifies a function of the function card to the control circuit.

6. An electronic imaging apparatus comprising:
an image signal generator;
a control circuit that controls memory operations and transfer and transmissions of an image signal generated by the image signal generator;
a bus that connects the image signal generator and the control circuit;
an opening for receiving a plurality of function cards each having a thickness, wherein a width of the opening corresponds to a sum of the thicknesses of the plurality of function cards; and
a plurality of connectors corresponding to the plurality of function cards, wherein the connectors connect the plurality of function cards to the bus, and each connector is adapted to receive each of a plurality of kinds of function cards.

7. An electronic imaging apparatus according to claim 6, wherein when a function card, having a thickness that is an integer multiple of a unit thickness and having one connector terminal, is housed in the opening, the one connector terminal is connected to one of the plurality of connectors.

8. An electronic imaging apparatus according to claim 6, wherein when a function card that is housed in the opening is a memory card having a memory circuit, the control circuit stores the image signal generated by the image signal generator in the memory circuit of the memory card.

9. An electronic imaging apparatus according to claim 6, wherein when the plurality of function cards are housed in the opening, the plurality of function cards including a memory card having a memory circuit and an interface card for interfacing the electronic imaging apparatus and an external device, the control circuit stores the image signal generated by the image signal generator in the memory circuit of the memory card and transfers the image signal to the external device through the interface card.

10. An electronic imaging apparatus according to claim 6, wherein when the plurality of function cards housed in the opening includes a memory card having a memory circuit and a communication card for connecting to an external device through a communication circuit, the control circuit stores the image signal generated by the image signal generator in the memory circuit of the memory card and transmits the image signal to the external device through the communication card.

11. An electronic imaging apparatus according to claim 6, wherein when the plurality of function cards housed in the opening includes a memory card having a memory circuit and an interface card for interfacing the electronic imaging apparatus with an external device, the control circuit transfers an image signal from the external device to the memory circuit of the memory card through the interface card.

12. An electronic imaging apparatus according to claim 6, further comprising a memory, wherein when the plurality of function cards housed in the opening includes an interface card for interfacing the electronic imaging apparatus with an external device, program data are transferred from the external device to the memory through the interface card and stored in the memory for execution by the control circuit.

13. An electronic imaging apparatus according to claim 6, wherein when the plurality of function cards received in the opening includes a memory card having a memory circuit and a communication card for communicating with an external device through a communication circuit, and the control circuit transfers an image signal from the external device to the memory circuit of the memory card through the communication card.

14. An electronic imaging apparatus according to claim 6, further comprising a first memory, wherein when the plurality of function cards received in the opening includes a communication card for communicating with an external device through a communication circuit, program data are transmitted from the external device to the first memory through the communication card and stored in the first memory for execution by the control circuit.

15. An electronic imaging method comprising the steps of:
providing an electronic imaging apparatus having:
an image signal generator;
a control circuit that controls memory operations and transfer and transmissions of an image signal generated by the image signal generator;
a bus that connects the image signal generator and the control circuit;
an opening for housing a plurality of function cards having a unit thickness, wherein a width of the opening corresponds to a sum of the unit thicknesses of the plurality of function cards; and
a plurality of connectors corresponding to the plurality of function cards, wherein the connectors connect the plurality of function cards to the bus, and each connector is adapted to receive each of a plurality of kinds of function cards;
connecting at least one function card to a corresponding one of the plurality of connectors; and
transferring image signal data between the bus and the at least one function card.

16. The method of claim 15, further comprising the steps of:
connecting a memory card and one of an interface card and a communication card to corresponding ones of the plurality of connectors; and
simultaneously transferring image signal data generated by the image signal generator to both the memory card and the one of the interface card and the communication card.

17. The method of claim 15, further comprising the steps of:
connecting a memory card and one of an interface card and a communication card to corresponding ones of the plurality of connectors; and
transferring image signal data received from an external device via the one of the interface card and the communication card to the memory card.

18. The method of claim 15, further comprising the steps of:
providing a memory within the electronic imaging apparatus;
connecting at least one of an interface card and a communication card to corresponding ones of the plurality of connectors; and
transferring control program data from an external device to the memory via one of the at least one of interface card and communication card.

19. The method of claim 15, further comprising the steps of:
providing a switching device in the electronic imaging apparatus;
connecting at least one of a memory card, an interface card, and a communication card to corresponding ones of the plurality of connectors; and
actuating the switching device to identify the at least one of the memory card, the interface card, and the communication card.

20. An electronic imaging apparatus comprising:
image signal generating means for generating an image signal;
control means for controlling memory operations and transferring and transmitting the image signal generated by the image signal generator;
a bus that connects the image signal generating means and the control means;
an opening for receiving a plurality of function cards having a unit thickness, wherein a width of the opening corresponds to a sum of the unit thicknesses of the plurality of function cards; and
a plurality of connectors, each connector adapted to connect a plurality of kinds of function cards to the bus.

21. An electronic imaging apparatus according to claim 20, wherein when a function card having a thickness that is an integer multiple of the unit thickness and having one connector terminal is housed in the opening, the one connector terminal is connected to one of the plurality of connectors.

22. An electronic imaging apparatus according to claim 20, wherein when a function card housed in the opening is a memory card having a memory circuit, the control means stores the image signal generated by the image signal generating means in the memory circuit of the memory card.

23. An electronic imaging apparatus according to claim 20, wherein when a plurality of function cards are housed in the opening and the plurality of function cards includes a memory card having a memory circuit and an interface card for interfacing the electronic imaging apparatus and an external device, the control means simultaneously stores the image signal generated by the image signal generating means in the memory circuit of the memory card and transfers the image signal to the external device through the interface card.

24. An electronic imaging apparatus according to claim 20, wherein when the plurality of function cards housed in the opening includes a memory card having a memory circuit and a communication card for connecting to an external device through a communication circuit, the control means stores the image signal generated by the image signal generating means in the memory circuit of the memory card and transmits the image signal to the external device through the communication card.

25. An electronic imaging apparatus according to claim 20, wherein when the plurality of function cards housed in the opening includes a memory card having a memory circuit and an interface card for interfacing the electronic imaging apparatus with an external device, the control means transfers an image signal from the external device to the memory circuit of the memory card through the interface card.

26. An electronic imaging apparatus according to claim 20, further comprising memory means, wherein when the plurality of function cards housed in the opening includes an interface card for interfacing the electronic imaging apparatus with an external device, program data are transferred from the external device via the interface card to the memory means and stored in the memory means for execution by the control means.

27. An electronic imaging apparatus according to claim 20, wherein when the plurality of function cards housed in the opening includes a memory card having a memory circuit and a communication card for communicating with an external device through a communication circuit, the control means transfers an image signal from the external device to the memory circuit of the memory card through the communication card.

28. An electronic imaging apparatus according to claim 20, further comprising first memory means, wherein when the plurality of function cards housed in the opening includes a communication card for communicating with an external device through a communication circuit, program data are transmitted from the external device to the first memory means through the communication card and stored in the first memory means for execution by the control means.

29. An electronic imaging apparatus according to claim 20, further comprising:
switching means, wherein the switching means sets card identification information that identifies a function card connected to one of the plurality of connectors.
